(19) United States
(12) Patent Application Publication
(10) Pub. No.: US 2026/0118127 A1
(43) Pub. Date: Apr. 30, 2026

(54) RESIDENT SPACE OBJECT CATALOG MANAGEMENT FOR CELESTIAL NAVIGATION

(71) Applicant: The Charles Stark Draper Laboratory, Inc., Cambridge, MA (US)

(72) Inventors: Derek Tuggle, Cambridge, MA (US); Brian Dolle, Cambridge, MA (US)

(21) Appl. No.: 19/368,213

(22) Filed: Oct. 24, 2025

Related U.S. Application Data
(60) Provisional application No. 63/711,224, filed on Oct. 24, 2024.

(51) Int. Cl. G01C 21/02

(52) U.S. Cl. CPC G01C 21/02

(57) ABSTRACT

A system for selecting one or more resident space objects from a number of resident space objects for targeting includes a database for storing properties of the resident space objects and one or more processors. The processors are configured to determine, for each resident space object, a utility metric representing a navigation utility of the resident space object. Determining the utility metric includes determining a projected position of the resident space object by projecting a position of the resident space object over time based on ephemeris data and covariance data associated with the resident space object, and computing the utility metric based at least in part on the projected position. The processors rank the resident space objects according to their utility metrics and select the one or more resident space objects for targeting based on the ranking.

### CROSS-REFERENCES TO RELATED APPLICATIONS

This application claims the benefit of U.S. Provisional Application No. 63/711,224 filed Oct. 24, 2024, the entire contents of which are incorporated herein by reference.

### BACKGROUND OF THE INVENTION

A resident space object (RSO) is a natural or artificial object that orbits another body. Satellites and space debris orbiting Earth are common examples of resident space objects. Some celestial navigation systems (e.g., The Charles Stark Draper Laboratory's “Skymark” system) rely on the relative positions of stars and resident space objects to determine accurate position and orientation information for land vehicles, aircraft, maritime vehicles, military assets, etc.

Celestial navigation systems are useful for applications that require localization in GPS-denied or GPS-degraded environments, including military operations where GPS signals may be jammed or spoofed, deep space missions beyond GPS satellite coverage, and other scenarios requiring high-integrity localization independent of GPS or other radio-frequency-based systems. Celestial navigation systems use optical sensors (e.g., cameras) to image RSOs against the star background and process the images to extract line-of-sight measurements that are fused with other sensor data (e.g., inertial sensor data) to estimate the vehicle's position and orientation.

### SUMMARY OF THE INVENTION

Some celestial navigation systems maintain a catalog of RSOs and their associated ephemerides (i.e., data that describes the precise position and velocity of the object in space at a specific time) as well as orbital elements (e.g., semi-major axis, eccentricity, inclination, etc.), and covariance information characterizing the uncertainties associated with the ephemeris). Such systems rely on knowing a position of RSOs at the time that the RSOs are detected (e.g., imaged). But the ephemerides of the RSOs are associated with a specific time in the past, so the systems need to propagate the position from the time in the past to the time the RSOs are detected to determine an estimated position of the RSOs.

It is important that the propagated positions of RSOs are both useful for navigation and accurate, however there can be a large variance across the RSOs in the catalog in terms of both (1) the navigation utility of propagated resident space object ephemerides (i.e., a measure of how effectively an RSO observation contributes to the navigation system's position estimate) and (2) how well propagated resident space object ephemerides reflect reality (i.e., how accurately covariances of the resident space objects capture errors in reported resident space object positions). A celestial navigation system that fails to account for the variances across the resident space objects runs the risk of reduced navigation performance.

Some conventional celestial navigation systems treat all RSOs in a catalog uniformly, and do not account for variations in ephemeris accuracy and navigation utility across different objects. Because RSO ephemerides may degrade at different rates depending on orbital altitude, atmospheric effects, and observation recency, uniform treatment of RSOs in a catalog may result in the celestial navigation system using RSOs with poor or unreliable ephemeris data. This can cause increased navigation errors and force premature replacement of the entire catalog even when many RSOs remain highly useful. The technical problem can be compounded in GPS-denied environments where celestial navigation is the primary positioning method and navigation errors directly impact mission success.

Aspects described herein address this technical problem by automatically evaluating and selecting RSOs based on their time-varying navigation utility. Aspects account for orbital dynamics, ephemeris degradation, and covariance calibration to identify which RSOs will provide accurate positioning information at specific times during a mission. This technological improvement increases navigation accuracy by selecting RSOs with high-quality ephemerides and extends the operational lifetime of RSO catalogs by continuing to use high-quality RSOs even after other RSOs have degraded. The result is improved mission success rates in GPS-denied navigation scenarios and reduced operational costs associated with catalog updates.

Some aspects described herein relate to managing the catalog of resident space objects to ensure that a celestial navigation system uses resident space objects in the catalog that are more likely to yield useful and accurate expected locations when their motion is propagated as compared to other conventional systems. As is described in greater detail below, aspects account for navigation utility of RSOs in the catalog and how well propagated RSO ephemerides reflect reality when selecting both (1) which RSOs to propagate and (2) what RSOs to sight for navigation. The catalog management technique described herein advantageously increases navigation accuracy and increases mission holdover (i.e., a period for which the propagated catalog provides suitable celestial navigation).

Some aspects use a probabilistic metric for characterizing navigation utility of an RSO. Aspects may use the metric to formulate greedy and non-greedy RSO management processes. The greedy version can favor navigation performance at the current time, without regard to navigation performance at future times. The non-greedy version takes into account navigation performance at future times when selecting the RSO for navigation at the current time. This improves navigation performance with respect to the entire mission at the cost of increased computation.

In a general aspect, a system for selecting one or more resident space objects from a number of resident space objects for targeting includes a database for storing properties of the number of resident space objects. The system includes one or more processors configured to process the number of resident space objects stored in the database to select the one or more resident space objects for targeting. The one or more processors are configured to determine, for each resident space object of the number of resident space objects, a utility metric representing a navigation utility of the resident space object. The determining of the utility metric for the resident space object includes determining a projected position of the resident space object by projecting a position of the resident space object over time based on ephemeris data and covariance data associated with the resident space object, and computing the utility metric based at least in part on the projected position of the resident space object. The one or more processors are configured to rank the resident space objects of the number of resident space objects according to their utility metrics, and select the one or more resident space objects for targeting based on the ranking.

Aspects may include one or more of the following features.

The one or more processors may be configured to determine the projected position by propagating the resident space object's position and velocity forward in time using a dynamical model. The one or more processors may be further configured to propagate uncertainty in the resident space object's position by propagating the covariance data associated with the ephemeris data.

The one or more processors may be further configured to, prior to determining utility metrics, remove resident space objects from the number of resident space objects based on staleness of their ephemeris data. The staleness may be determined based on a time elapsed since an epoch of the ephemeris data to an orbital period of the resident space object.

The one or more processors may be configured to compute the utility metric by rotating the covariance data into a calibration coordinate frame, applying calibration scaling factors to the covariance data in the calibration coordinate frame, and rotating the calibrated covariance data back to an inertial reference frame. The calibration coordinate frame may be one of: radial-transverse-normal coordinates and equinoctial coordinates.

The one or more processors may be configured to select the one or more resident space objects by performing a non-myopic optimization that accounts for navigation performance at multiple future times when selecting resident space objects for targeting at a current time. Alternatively, the one or more processors may be configured to select the one or more resident space objects in a way that accounts for navigation performance at a current time without regard to navigation performance at future times.

The system may further include an optical sensor configured to capture images of the selected one or more resident space objects. The one or more processors may be further configured to process the images to extract line-of-sight measurements to the selected resident space objects, update a state estimate using the line-of-sight measurements, and provide the updated state estimate to a guidance and control module.

The one or more processors may be further configured to perform offline catalog management prior to determining utility metrics during operation of the system. The offline catalog management may include identifying and removing resident space objects that have deorbited, identifying and removing resident space objects having altitudes below a threshold altitude, adding new resident space objects from a tracking service, and calibrating covariance data for resident space objects. Calibrating covariance data may include propagating a resident space object from a first known ephemeris to a second known ephemeris, comparing the propagated position to an observed position at the second ephemeris, determining a scaling factor based on inconsistency between the covariance data and observed error, and determining a probability distribution characterizing uncertainty in the scaling factor. The threshold altitude may be approximately 800 kilometers above Earth's surface.

The utility metric may include a probability that a position error metric is less than a predetermined navigation error requirement. The one or more processors may be further configured to project the utility metric of each resident space object onto a current uncertainty estimate.

The system may further include an optical sensor, and the optical sensor may include a camera configured to image both resident space objects and stars. The one or more processors may be configured to select the one or more resident space objects for targeting by a celestial navigation system. The one or more processors may be configured to provide the selected one or more resident space objects to a celestial navigation system for targeting.

The utility metric may be further based on covariance calibration parameters and their uncertainties, resident space object brightness (e.g., is the object visible?), and a relative geometry of the resident space object with the celestial navigation system.

The method may further include identifying resident space objects that deorbited during projection and removing the identified resident space objects from consideration by the ranking.

The method may further include identifying resident space objects with stale ephemeris data and removing the identified resident space objects from consideration by the ranking.

The method may further include identifying resident space objects with an altitude less than a threshold altitude and removing the identified resident space objects from consideration by the ranking.

At least some aspects of the method may be performed prior to deployment of the celestial navigation system.

In another general aspect, a method for selecting one or more resident space objects from a number of resident space objects for targeting includes, for each resident space object of the number of resident space objects, determining a utility metric representing a navigation utility of the resident space object. The determining of the utility metric for the resident space object includes determining a projected position of the resident space object by projecting a position of the resident space object over time based on ephemeris data and covariance data associated with the resident space object, and computing the utility metric based at least in part on the projected position of the resident space object. The method includes ranking the resident space objects of the number of resident space objects according to their utility metrics, and selecting the one or more resident space objects for targeting based on the ranking.

In another general aspect, a non-transitory computer-readable medium stores instructions that, when executed by one or more processors, cause a system to, for each resident space object of a number of resident space objects, determine a utility metric representing a navigation utility of the resident space object by determining a projected position of the resident space object by projecting a position of the resident space object over time based on ephemeris data and covariance data associated with the resident space object, and computing the utility metric based at least in part on the projected position of the resident space object. The instructions cause the system to rank the resident space objects of the number of resident space objects according to their utility metrics, and select one or more resident space objects for targeting based on the ranking.

In another general aspect, a celestial navigation system for a vehicle includes an optical sensor configured to capture images of resident space objects and stars, a database storing ephemeris data and covariance data for a number of resident space objects, one or more processors, and memory storing instructions that, when executed by the one or more processors, cause the celestial navigation system to receive ephemeris data and covariance data for the number of resident space objects orbiting Earth. For each resident space object of the number of resident space objects, the celestial navigation system determines a utility metric representing a navigation utility of the resident space object to the celestial navigation system. The utility metric is based at least in part on the projected position of the resident space object, calibrated covariance data characterizing uncertainty in the projected position, and a geometric relationship between the resident space object and the celestial navigation system. The celestial navigation system ranks the resident space objects of the number of resident space objects according to their utility metrics, selects one or more resident space objects for targeting based on the ranking, and controls the optical sensor to capture images of the selected one or more resident space objects to determine a navigation solution for the vehicle. The navigation solution is used to control guidance of the vehicle.

Among other advantages, managing the RSO catalog according to aspects described herein advantageously improves navigation performance as well as improving holdover (operational) lifetime of the catalog. In particular, some RSOs are usable for much longer than others, and the current, fixed holdover requirement on some RSO catalogs may not account for that fact. Aspects described herein maximize the catalog, relying on RSOs for as long as they are actually usable.

The RSO catalog management techniques described herein advantageously provide technological improvements for celestial navigation systems deployed in various applications requiring accurate position determination without reliance on GPS or other radio-frequency navigation systems.

Aspects are advantageously applicable in military applications such as navigation systems for missiles, aircraft, and unmanned aerial vehicles operating in GPS-denied or GPS-degraded environments where adversaries may jam or spoof GPS signals.

Aspects are advantageously applicable in space missions such as navigation for satellites in Earth orbit, interplanetary spacecraft, and missions to the Moon or Mars where GPS coverage is unavailable. The ability to extend catalog lifetime advantageously reduces communication requirements and operational complexity for deep space missions.

Aspects advantageously improve navigation performance as well as improve holdover (operational) lifetime of the catalog. For example, some RSOs are usable for much longer than others, and the current, fixed holdover requirement on some RSO catalogs may not account for that fact. Aspects described herein maximize the catalog, relying on RSOs for as long as they are actually usable.

### BRIEF DESCRIPTION OF THE DRAWINGS

FIG. 1 is an airborne platform navigating using a celestial navigation system.

FIG. 2 is a celestial navigation system.

FIG. 3 is an offline RSO catalog management module.

FIG. 4 is an online RSO catalog management module.

### DETAILED DESCRIPTION

### 1 Overview

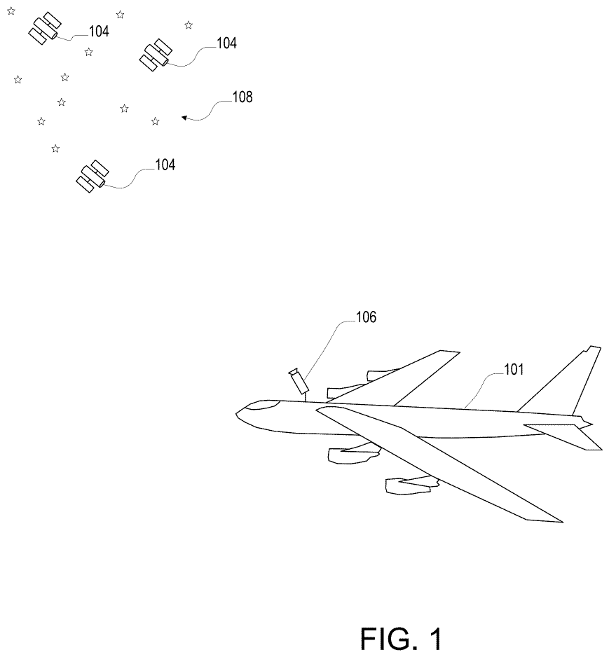

Referring to FIG. 1, an airborne platform (or vehicle) 101 such as aircraft is shown navigating using a celestial navigation system (described in greater detail below). The platform 101 carries a camera 106 configured to capture images of resident space objects (RSOs) 104 orbiting Earth against a star background 108. The RSOs 104 can include satellites and other objects in Earth orbit. The camera 106 provides line-of-sight measurements to the RSOs 104, which are used by the celestial navigation system to determine position and orientation information for the aircraft 101. Very generally, this approach enables navigation without reliance on GPS or other radio-frequency based systems, making it particularly valuable for applications requiring navigation in GPS-denied or GPS-degraded environments.

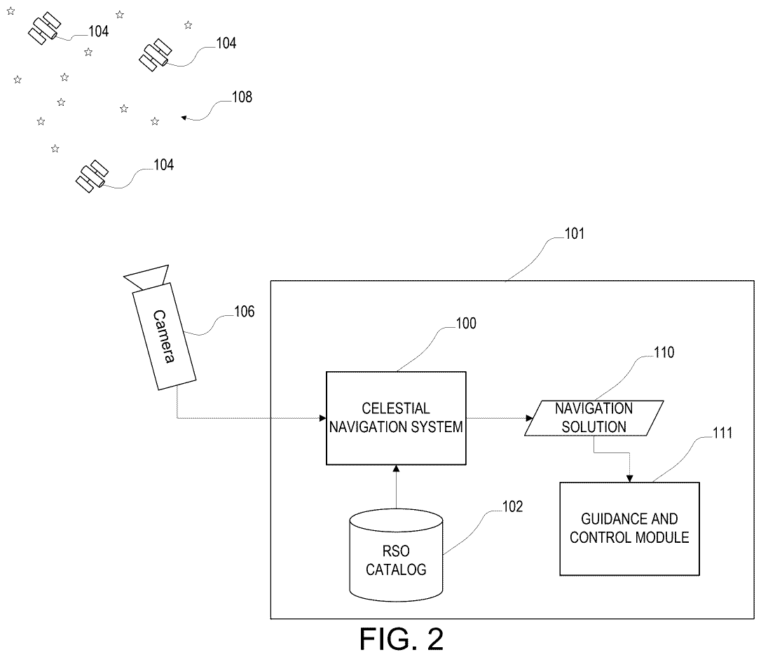

Referring to FIG. 2, the platform 101 (e.g., the aircraft) includes a celestial navigation system 100 that maintains a catalog 102 of resident space objects (RSOs) 104 and their respective ephemerides. In general, the ephemeris for each of the RSOs in the catalog is data that describes the precise position and velocity of the object in space at a specific time as well as orbital elements (e.g., semi-major axis, eccentricity, inclination, etc.), and covariance information characterizing the uncertainties associated with the ephemeris.

In operation, the celestial navigation system 100 uses a camera 106 to obtain line-of-sight images of a selected subset of the resident space objects 104 in the catalog 102. The star background 108 also captured in the images is used as a frame of reference to determine a direction in which the camera 106 is pointed. The system 100 processes the images from the camera 106 to determine a navigation solution 110 (e.g., an estimated location and direction of the system 100). The navigation solution 110 is provided to a guidance and control module 111, which uses the navigation solution 110 to guide and control the platform 101. In some examples, the celestial navigation system 100 maintains a continuous estimate of its state (e.g., the location and direction of the system). At any given time, an expected location of each of the resident space objects 104 captured in the images is determined by propagating the motion of the objects along their orbits according to their respective ephemerides from the catalog 102 (e.g., using a dynamical model of the resident space object's motion such as a models of geopotential gravity, atmospheric drag, and solar radiation pressure).

The angular difference between a particular resident space object's expected location and its measured location on the camera's focal plane is determined and used to update the system's state estimate using Kalman filter equations. Further details of an example of a celestial navigation system can be found in Willhite, W. B., An Analysis of ICBM Navigation Using Optical Observations of Existing Space Objects, CSDL-T-1484, Masters Thesis, Massachusetts Institute of Technology, June 2004, the entire contents of which are hereby incorporated by reference.

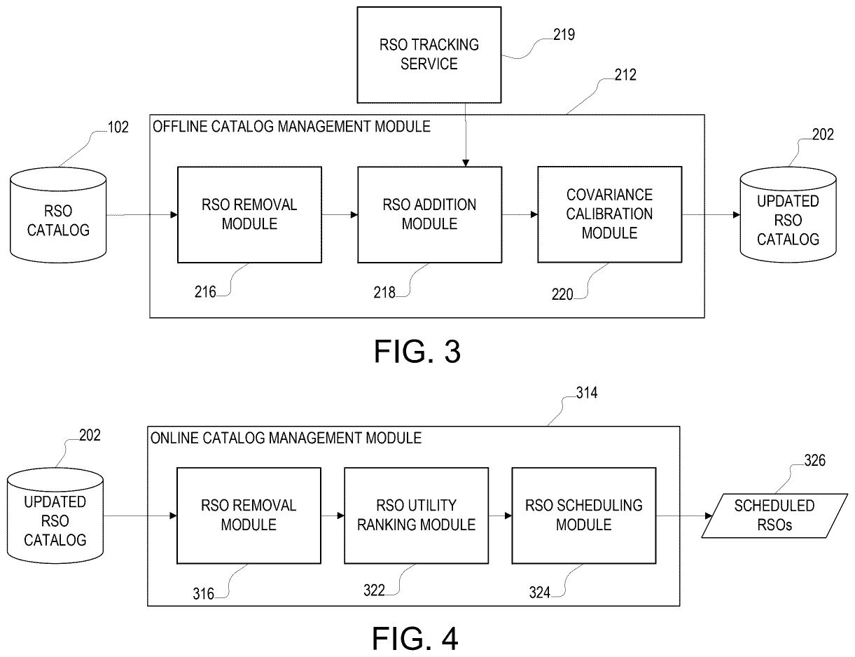

Referring to FIGS. 3 and 4, in some examples, a catalog management scheme is used to increase navigation accuracy and mission holdover time. As used herein, the term “mission holdover time” refers to the time duration for which a propagated RSO catalog provides suitable accuracy for celestial navigation without requiring updated ephemeris data from external tracking sources. For example, if a celestial navigation system begins operation with an RSO catalog having ephemeris data with epochs at time t₀, the mission holdover time is the maximum time duration Δtₕ for which RSOs in the catalog can be propagated forward (i.e., to times t₀+Δt) and still provide navigation measurements meeting the system's accuracy requirements.

In general, the mission holdover time is not uniform across all RSOs in a catalog. Some RSOs, particularly those in stable orbits with well-characterized dynamics and recently updated ephemerides, may remain useful for extended periods. Other RSOs, such as those in low Earth orbits subject to significant atmospheric drag or those with older ephemeris data, may have much shorter useful lifetimes. The catalog management techniques described herein account for these variations, allowing the celestial navigation system to continue using high-quality RSOs even after other RSOs in the catalog have become unsuitable.

In some examples, catalog management is implemented using two separate but related modules: (1) an offline catalog management module 212 and (2) an online catalog management module 314.

### 2 Offline Catalog Management

Referring to FIG. 3, the offline catalog management module 212 is used prior to the celestial navigation system's use of the catalog 102 to determine navigation solutions. Very generally, the offline catalog management module 212 refines the RSO catalog 102 prior to deployment of the celestial navigation system to generate an updated RSO catalog 202 that includes high-quality RSOs suitable for deployment with the celestial navigation system.

In some examples, the offline catalog management module 212 includes a resident space object (RSO) removal module 216, a resident space object (RSO) addition module 218, and a covariance calibration module 220.

### 2.1 RSO Removal Module

The RSO removal module 216 identifies and removes certain RSOs that are unlikely to contribute to the celestial navigation system from the catalog 102. For example, the RSO removal module 216 propagates some or all of the RSOs in the catalog and then identifies RSOs in the catalog that have deorbited (e.g., based on a propagation log) and discards those RSOs. The RSO removal module 216 may also identify certain RSOs in the catalog that are below a predetermined altitude (e.g., objects lower than 800 km from Earth's surface) and discard those RSOs because the effects of Earth's atmosphere on those RSOs make their trajectories difficult to accurately propagate.

### 2.2 RSO Addition Module

The RSO addition module 218 receives information about new RSOs (e.g., from a service 219 such as space-track.org) and processes that information to identify RSOs to add to the RSO catalog. For example, the RSO addition module 218 receives a list of new RSOs and their associated ephemerides and covariance information and analyzes the new RSOs to first discard any of the new RSOs that are deorbited or below the predetermined altitude threshold (as described above). The RSO addition module 218 may also perform brightness modeling and discard any of the new RSOs that are not easily visible to the celestial navigation system's camera.

The RSO addition module 218 also propagates the new RSOs according to their ephemerides and covariance information to ensure that the covariance information of the RSOs remains consistent throughout propagation. Any of the new RSOs with covariance information that increases drastically throughout propagation are discarded. Similarly, any of the new RSOs that behave erratically throughout propagation are discarded. Any remaining new RSOs are added to the RSO catalog.

### 2.3 Covariance Calibration Module

The covariance calibration module 220 then calibrates the covariance information for the remaining RSOs in the RSO catalog. In some examples, the covariance calibration information associated with the RSOs may need to be updated periodically (e.g., every three months). To update the covariance calibration information for an RSO, the RSO can be propagated between two known ephemerides according to the covariance information for the RSO and the propagated position of the RSO can be compared to the known actual position of the RSO to determine an error. Inconsistency between the error and covariance is used to generate a scaling value that can be applied to covariance information in the RSO catalog to correct the covariance information for the RSO. In some examples, the covariance calibration module 220 also determines a probability distribution associated with the scaling value.

The result of processing the RSO catalog 102 in the RSO removal module 216, the RSO addition module 218, and the covariance calibration module 220 is output from the offline catalog management module 212 as the updated RSO catalog 202, which is later used in a deployed celestial navigation system.

In some examples, the offline catalog management module 212 executes on ground-based computing systems prior to vehicle deployment, and the catalog is then loaded into the vehicle's onboard computing system along with the celestial navigation software at deployment.

### 3 Online Catalog Management

Referring to FIG. 4, the online catalog management module 314 is used by the celestial navigation system 100 during the deployment of the celestial navigation system as part of the system's use of the updated RSO catalog 202 (generated in FIG. 3) to determine navigation solutions. Very generally, the online catalog management module 314 further refines the updated RSO catalog 202, ranks RSOs according to their navigation utilities, and then schedules RSOs for targeting using the ranked RSOs. The output of the online catalog management module 314 is a set of scheduled RSOs 326 that are used by the celestial navigation system.

In some examples, the online catalog management module 314 includes an RSO removal module 316, an RSO utility ranking module 322, and an RSO scheduling module 324.

### 3.1 RSO Removal Module

The RSO removal module 316 removes RSOs from the updated RSO catalog 202 if the RSOs are “stale” (the RSOs have not been observed for a predetermined time duration) and removes deorbited RSOs from the updated RSO catalog 202.

In some examples, the RSO removal process occurs in two stages to improve computational efficiency. In the first stage, RSOs with stale ephemeris data are removed from consideration before propagation is performed. This avoids the computational cost of propagating RSOs that are known to have outdated ephemeris data. In some examples, staleness is determined by calculating the time elapsed since the RSO's ephemeris epoch and comparing it to the RSO's orbital period.

In the second stage, after propagating the remaining RSOs forward in time, the system identifies and removes any RSOs that deorbited during the propagation period. This two-stage approach efficiently filters the catalog while ensuring that all remaining RSOs have both recent ephemeris data and viable orbits throughout the mission duration.

In particular, any of the RSOs that are “stale” are removed from the RSO catalog by the RSO removal module 316. For example, a “staleness” value for an RSO is defined as the current time minus the time the RSO was observed (i.e., the epoch). If the staleness value for the RSO is greater than an orbital period of the RSO, Tᵢ multiplied by some threshold value, τᵢ (i.e., τᵢ×Tᵢ), then the RSO is removed from the catalog.

In some examples, the staleness value for an RSO is calculated as:

$$staleness = current time - epoch time$$

where
current time is the current mission time or processing time, and
epoch time is the epoch time associated with the RSO's ephemeris data (i.e., the time at which the RSO was last observed and its position and velocity were determined)

The threshold for determining whether an RSO is too stale is determined based on the RSO's orbital period, Tᵢ. In particular, an RSO is too stale if:

$$staleness > ( {τ}_{i} \times {T}_{i} )$$

where τᵢ is a predetermined threshold multiplier (where τᵢ is tuned on a per-satellite basis to capture the varied levels of orbital stability across different orbital regimes) and the RSO's orbital period Tᵢ is computed from the RSO's semi-major axis using Kepler's third law. If the above inequality evaluates to True, then the RSO is removed from consideration. This approach accounts for the fact that propagation accuracy degrades more rapidly for RSOs that have not been recently observed, and the degradation rate scales with the orbital period.

In the second stage, the remaining RSOs in the catalog are propagated from a current time to a mission holdover time plus a buffer time (e.g., 3 days) to generate propagation logs for the RSOs. Any RSOs with propagation logs that indicate that the RSOs deorbited during propagation are removed from the RSO catalog.

In some examples, the additional 3-day “buffer” beyond the mission holdover time ensures that RSOs approaching end-of-life are identified and removed from the catalog. By propagating beyond the planned mission duration, the system can detect RSOs that would deorbit near the end of the mission and exclude them from consideration, thereby maintaining catalog reliability throughout the entire mission.

### 3.2 RSO Utility Ranking Module

The RSO utility ranking module 322 processes the remaining RSOs to first determine a navigation utility for each RSO and then rank the RSOs according to their respective navigation utilities.

First, the RSO utility ranking module 322 rotates the covariances associated with the RSOs into a calibration frame (i.e., a coordinate system aligned with the RSO's orbital motion such as a radial-transverse-normal or equinoctial coordinate system) and then calibrates the covariances based on the covariances determined by the covariance calibration module 220 of FIG. 3. The calibrated covariances are rotated back to an inertial frame for the celestial navigation system (e.g., J2K).

The calibrated covariance values and propagated RSO states for the remaining RSOs are then used to determine a navigation utility metric for each of the remaining RSOs. In some examples, the navigation utility metric is calculated for all of the remaining RSOs at multiple time points spanning from a time t=0 to the mission holdover time plus buffer period. At each time step, the filter covariance is propagated to time t, and the navigation utility metric is calculated for all of the remaining RSOs at that time. In some examples, the navigation utility metric is defined as the probability that an error term, e is less than a navigation error requirement (e.g., a positional error requirement):

$$Pr ( ϵ ) < Nav Error Req .$$

where ∈ is defined as the minor-axis position error per RSO update, modeled as:

$$ϵ = ( true sat distance ) \sqrt{{( RSO angular error )}^{2} + {( star angular error )}^{2}}$$

$$and$$

$$RSO angular error = \sqrt{\frac{{e}_{C}^{2} + {e}_{R}^{2}}{{( true sat distance )}^{2}} + {( sensor noise )}^{2}}$$

where
e_{c}: crosstrack RSO ephemeris error, and
e_{R}: radial RSO ephemeris error.

In some examples, when the propagated RSO state and covariance are expressed in a calibration frame, the squared error budget term η² can be expressed as a ratio of non-central Chi-squared distributions, representing a generalized Rayleigh quotient. In such examples, the squared error budget term provides a statistical characterization of the normalized position error that accounts for both the magnitude of ephemeris errors and the geometric relationship between the RSO and Earth's surface.

In general, e_{c} and e_{R} come from the covariances determined by the covariance calibration module 220 of FIG. 3. The value of true sat distance is a “range” value from the propagated RSO states. The value of star angular error is a known bound for the star angular error that applies to all RSOs. The value of sensor noise is a known bound that applies to all RSOs and, in some examples, the sensor noise could map from the brightness models to particular RSOs.

The ephemeris error budget terms are nonlinear functions of both ephemeris error and true RSO state. Specifically, these terms depend on the true observation distance (range) between the celestial navigation system and the RSO. Computing the navigation utility metric Pr(∈)<Nav Error Req involves approximating integrals of nonlinear transformations of X, the RSO state vector, where ∈ is itself a nonlinear function of X that depends on the geometric relationship between the RSO and the observer.

In some examples, the full transformation from RSO state uncertainty to the navigation utility metric does not conform to a closed-form probability distribution family. For example, while the underlying ephemeris errors may follow Gaussian distributions and the normalized error η² may follow a Chi-squared distribution, the transformation through the minor-axis position error formula may involve additional nonlinearities from geometric factors, sensor noise, and star angular error contributions. The navigation utility metric is therefore evaluated numerically using importance sampling methods such as Monte Carlo simulation.

In one example, the Monte Carlo simulation process begins by generating a large number of samples (e.g., 10,000 to 100,000 samples) from the joint probability distribution of RSO ephemeris errors (based on calibrated covariances), covariance calibration parameters and their uncertainties, and other random variables affecting the error term (e.g., sensor noise).

For each of the generated samples, a corresponding value of the error term ∈ is computed in a way that accounts for the sampled ephemeris error values, the true satellite distance (range) from the propagated RSO state, star angular error bounds, sensor noise characteristics, and geometric relationships with the observer.

Then, the fraction of samples for which e is less than the navigation error requirement threshold is determined, and the navigation utility metric Pr(∈)<Nav Error Req is estimated as the fraction.

Ultimately, the Monte Carlo simulation approach provides an accurate estimate of the navigation utility that accounts for the probability distributions of all contributing factors, including the uncertainties in the covariance calibration parameters determined by the covariance calibration module 220. In some examples, the error term, ∈ is a random variable that accounts for propagated RSO state and covariance, covariance calibration parameters and their uncertainties (capturing fidelity of the propagated solution), RSO brightness, and relative geometry with the observer.

The computed navigation utilities (including both epsilon and direction) for the RSOs are projected onto the current filter uncertainty ellipsoid. All the RSOs are then ranked based on their projected navigation utility.

### 3.3 RSO Scheduling Module

The RSOs, ranked according to projected navigation utility, are provided to the RSO scheduling module 324, which performs either a myopic (sometimes referred to as “greedy”) or non-myopic (sometimes referred to as “non-greedy”) optimization procedure to schedule RSOs for targeting by the celestial navigation scheme.

In general, the non-myopic optimization scheme selects RSOs to be targeted at the current time in a way that optimizes navigation performance over time (at the expense of requiring more complexity and time). The myopic optimization scheme selects RSOs to be targeted at the current time to optimize current navigation performance without considering navigation performance in the future. Regardless of which selection scheme is used, the output of the RSO scheduling module is the scheduled RSO's 326. In some examples, the RSO scheduling module also outputs predicted navigation performance for the scheduled RSOs (e.g., by running a filter to simulate processing at each RSO).

After selecting an RSO to target at the current time t and simulating the processing of that RSO measurement through the filter, the system predicts the filter state to the next potential measurement time, t+1. This prediction step propagates the filter's state estimate and associated uncertainty (covariance) forward in time according to the dynamics of the platform carrying the celestial navigation system.

In some examples, the filter prediction accounts for platform motion (e.g., aircraft or missile trajectory), process noise associated with uncertainties in platform dynamics, and time between potential RSO observation opportunities. The predicted filter state and uncertainty at time t+1 then serve as the basis for evaluating navigation utilities of RSOs at the next time step. This iterative process of RSO selection, filter update simulation, and filter prediction continues throughout the mission planning horizon or operational period.

In the non-myopic optimization approach, the filter prediction step may be particularly important because the predicted uncertainty at time t+1 (and subsequent times) depends on which RSO was selected at time t. The optimization considers how current RSO selections affect the filter uncertainty evolution and consequently, the navigation utility of RSOs at future times.

The selected RSOs are output from the online catalog management module 314 as the scheduled RSOs 326.

In some examples, during vehicle operation, the online catalog management module 314 executes on the vehicle's onboard processors, performing real-time or near-real-time RSO selection and scheduling.

### 3.4 Example Parameter Values and Thresholds

The following example parameter values and thresholds may be used in the catalog management process, though these values may be adjusted based on specific mission requirements.

For offline catalog management, the altitude threshold for RSO removal is 800 km (i.e., RSOs below that altitude are removed due to atmospheric drag effects). The covariance calibration is performed on the order of every 3 months. The covariance scaling factors vary depending on RSO characteristics. The brightness threshold is typically determined such that dimmer objects may be excluded.

For online catalog management, the staleness threshold multiplier typically some multiple of the orbital period. The mission holdover time for catalog evaluation is in a range from 10 to 15 days from the current time. In some examples, RSOs are propagated an additional 3 days beyond mission holdover time. In some examples, the navigation error requirement, Nav Error Req is mission dependent.

In some examples, the greedy (myopic) optimization approach has relatively modest computational overhead compared to the non-greedy approach. The non-greedy optimization approach has higher computational requirements due to the need to evaluate future time steps and their impact on navigation performance. The actual computational time depends on factors including the planning horizon, the number of RSOs considered, and the available processing hardware. In some embodiments, the system may adaptively switch between greedy and non-greedy approaches based on available computational resources and mission phase.

RSO selection using the utility-based ranking and selection techniques described herein provides improved navigation performance compared to conventional approaches that use random selection, brightness-based selection, or other non-optimized selection criteria. Similarly, the dynamic catalog management approach can extend effective catalog lifetime compared to fixed holdover time approaches that discard the entire catalog after a predetermined period, regardless of individual RSO quality. These improvements translate directly to enhanced mission success probability and reduced requirements for in-mission catalog updates.

### 4 Implementations

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A system for selecting one or more resident space objects from a plurality of resident space objects for targeting, the system comprising:
a database for storing properties of the plurality of resident space objects;
one or more processors configured to process the plurality of resident space objects stored in the database to select the one or more resident space objects for targeting, the one or more processors configured to:
determine, for each resident space object of the plurality of resident space objects, a utility metric representing a navigation utility of the resident space object, the determining of the utility metric for the resident space object including:
determining a projected position of the resident space object by projecting a position of the resident space object over time based on ephemeris data and covariance data associated with the resident space object; and
computing the utility metric based at least in part on the projected position of the resident space object;
rank the resident space objects of the plurality of resident space objects according to their utility metrics; and
select the one or more resident space objects for targeting based on the ranking.

2. The system of claim 1, wherein the one or more processors are configured to determine the projected position by propagating the resident space object's position and velocity forward in time using a dynamical model.

3. The system of claim 1, wherein the one or more processors are further configured to propagate uncertainty in the resident space object's position by propagating the covariance data associated with the ephemeris data.

4. The system of claim 1, wherein the one or more processors are further configured to, prior to determining utility metrics, remove resident space objects from the plurality of resident space objects based on staleness of their ephemeris data.

5. The system of claim 4, wherein staleness is determined based on a time elapsed since an epoch of the ephemeris data to an orbital period of the resident space object.

6. The system of claim 1, wherein the one or more processors are configured to compute the utility metric by:
rotating the covariance data into a calibration coordinate frame;
applying calibration scaling factors to the covariance data in the calibration coordinate frame; and
rotating the calibrated covariance data back to an inertial reference frame.

7. The system of claim 6, wherein the calibration coordinate frame is one of: radial-transverse-normal coordinates and equinoctial coordinates.

8. The system of claim 1, wherein the one or more processors are configured to select the one or more resident space objects by performing a non-myopic optimization that accounts for navigation performance at multiple future times when selecting resident space objects for targeting at a current time.

9. The system of claim 1, wherein the one or more processors are configured to select the one or more resident space objects in a way that accounts for navigation performance at a current time without regard to navigation performance at future times.

10. The system of claim 1, further comprising:
an optical sensor configured to capture images of the selected one or more resident space objects;
wherein the one or more processors are further configured to:
process the images to extract line-of-sight measurements to the selected resident space objects;
update a state estimate using the line-of-sight measurements; and
provide the updated state estimate to a guidance and control module.

11. The system of claim 1, wherein the one or more processors are further configured to perform offline catalog management prior to determining utility metrics during operation, the offline catalog management comprising:
identifying and removing resident space objects that have deorbited;
identifying and removing resident space objects having altitudes below a threshold altitude;
adding new resident space objects from a tracking service; and
calibrating covariance data for resident space objects.

12. The system of claim 11, wherein calibrating covariance data comprises:
propagating a resident space object from a first known ephemeris to a second known ephemeris;
comparing the propagated position to an observed position at the second ephemeris;
determining a scaling factor based on inconsistency between the covariance data and observed error; and
determining a probability distribution characterizing uncertainty in the scaling factor.

13. The system of claim 11, wherein the threshold altitude is approximately 800 kilometers above Earth's surface.

14. The system of claim 1, wherein the utility metric comprises a probability that a position error metric is less than a predetermined navigation error requirement.

15. The system of claim 1, wherein the one or more processors are further configured to project the utility metric of each resident space object onto a current uncertainty estimate.

16. The system of claim 1, further comprising an optical sensor, wherein the optical sensor comprises a camera configured to image both resident space objects and stars.

17. The system of claim 1, wherein the one or more processors are configured to select the one or more resident space objects for targeting by a celestial navigation system.

18. The system of claim 1, wherein the one or more processors are configured to provide the selected one or more resident space objects to a celestial navigation system for targeting.

19. A method for selecting one or more resident space objects from a plurality of resident space objects for targeting, the method comprising:
for each resident space object of the plurality of resident space objects, determining a utility metric representing a navigation utility of the resident space object, the determining of the utility metric for the resident space object including:
determining a projected position of the resident space object by projecting a position of the resident space object over time based on ephemeris data and covariance data associated with the resident space object; and
computing the utility metric based at least in part on the projected position of the resident space object;
ranking the resident space objects of the plurality of resident space objects according to their utility metrics; and
selecting the one or more resident space objects for targeting based on the ranking.

20. A non-transitory computer-readable medium storing instructions that, when executed by one or more processors of a system, cause the system to:
for each resident space object of a plurality of resident space objects, determine a utility metric representing a navigation utility of the resident space object to the system for the resident space object by:
determining a projected position of the resident space object by projecting a position of the resident space object over time based on ephemeris data and covariance data associated with the resident space object; and
computing the utility metric based at least in part on the projected position of the resident space object;
rank the resident space objects of the plurality of resident space objects according to their utility metrics; and
select one or more resident space objects for targeting based on the ranking.
